(19) United States
(12) Patent Application Publication
(10) Pub. No.: US 2015/0251661 A1
(43) Pub. Date: Sep. 10, 2015

(54) METHOD FOR PERMITTING A PERFORMANCE-ENHANCING NAP IN A MOTOR VEHICLE

(71) Applicant: FORD GLOBAL TECHNOLOGIES, LLC, Dearborn, MI (US)

(72) Inventors: Marcel Mathissen, Wurselen (DE); Rainer Vogt, Aachen (DE); Hans-Joachim Lindner, Euskirchen (DE); Jeroen Lem, Maastricht (DE); Volker Scheer, Roetgen (DE)

(21) Appl. No.: 14/642,806

(22) Filed: Mar. 10, 2015

(30) Foreign Application Priority Data
Mar. 10, 2014 (DE) 102014204339.5

(51) Int. Cl. B60W 40/08

(52) U.S. Cl. CPC B60W 40/08; B60W 2040/0827; B60W 2040/0872; B60W 50/08

(57) ABSTRACT

The invention relates to a method and a device for permitting a performance-enhancing nap in a motor vehicle. When a vehicle occupant requests a nap function, different vehicle parameters are set such that the performance-enhancing nap is promoted and the vehicle occupant enjoying the nap is woken at a specific time. According to the invention, during the nap function at least one physiological parameter of the vehicle occupant is measured, said parameter permitting conclusions to be drawn about the current depth of sleep, irrespective of any macromovements of the vehicle occupant, and the time at which the vehicle occupant is woken is selected by considering the at least one physiological parameter, such that the vehicle occupant is woken as far as possible at a time of light sleep.

### TECHNICAL FIELD

The invention relates to a method and a device for permitting a performance-enhancing nap in a motor vehicle.

### BACKGROUND

Driving long distances in a motor vehicle without taking breaks increases the risk of an accident. It is generally recognized that a drowsy driver should take a break and even more preferably, sleep a little.

It is known to provide a nap function in a motor vehicle to counteract drowsiness and/or to increase concentration levels, said nap function adjusting different vehicle parameters on request by a vehicle occupant such that a performance-enhancing nap in the vehicle is promoted. A particularly effective nap is a so-called “power nap”, i.e. a performance-enhancing nap which is preferably approximately 20 to 30 minutes long. A nap may also be a relaxed state which is used for recharging and which is characterized by a state of consciousness with increased relaxation. This state must not be perceived by the individual as sleep. Generally, the transition into the sleep state is seamless and the depth of sleep varies depending on the person. These conditions are also understood here as a nap.

For example, for a nap the windows and the sliding roof are closed, the doors locked, an intrusion/anti-theft alarm system and/or a system for monitoring the surroundings of the vehicle are switched on and the heating and ventilation and/or air conditioning appropriately adjusted. Moreover, a vehicle seat may be moved into a nap position which has been preset for the occupant, a lumbar support inflated, the passenger compartment darkened, for example by electrochromatic or mechanical window tinting and relaxing music played. After a preset time, the occupant is gently woken, also by reversing the measures taken for the nap.

The object of the invention is to permit a nap in a motor vehicle which is even more performance-enhancing.

### SUMMARY

This object is achieved by a method and a device having the features of the independent claims.

Advantageous developments of the invention are set forth in the dependent claims.

According to the invention, while the nap function is activated, one or more physiological parameters of the vehicle occupant are measured, said parameters permitting conclusions to be drawn about the current depth of sleep, irrespective of any macromovements of the vehicle occupant, and the time when the vehicle occupant is woken is selected by taking into consideration the at least one physiological parameter, such that the vehicle occupant is woken as far as possible at a time of light sleep.

For example, a device for waking a person sleeping in a motor vehicle is disclosed in DE 10 2008 038 022 A1, which uses a sleep phase alarm which determines (semi-) wakeful periods between deep sleep phases, during which the person may be gently woken, using movements of the person which are detected by a movement sensor, as provided for example for monitoring the interior. Such a sleep phase alarm is, however, inaccurate as only movements of whole body parts are detected, said movements also having to have a certain degree of intensity.

More reliable sleep phase alarms, which measure brain activity by means of special sensors on the head, are also provided but are very costly and uncomfortable.

The invention makes use of the fact that a number of sensor systems and data processing devices are present in modern vehicles or may be easily added and which permit, with or without a small additional cost, the measurement of physiological parameters of the vehicle occupant which are more subtle than macromovements and which are associated at least as accurately or even more reliably with the depth of sleep. Such parameters are, among other things, heart rate, breathing rate, blood pressure, body temperature, muscle tone, in particular facial muscle tone, electrical skin resistance and electrical brain activity.

Such parameters may be measured and processed in a motor vehicle without great effort and without discomfort for the vehicle occupant enjoying a nap. Sensors which are suitable therefore and which are already present for other purposes in some motor vehicles are, for example, sensors for ECG (electrocardiography), EMG (electromyography) and breathing rate which may be built into the seat or steering wheel and electronic cameras which, for example, permit the detection of facial muscle tone and body temperature. Even a device built into the motor vehicle and, for example, attached to the body of the driver, such as for example an armband equipped with a sensor, would be less disruptive in a motor vehicle seat than in a bed where more freedom of movement is expected than in a motor vehicle seat.

A few possible indicators for light sleep may also be associated with specific external body movements, such as for example flaring nostrils, twitching eyelids or the pulsation of blood vessels under the skin but these micromovements are movements which are not detected at all by typical movement sensors but which may be identified by suitable evaluation techniques, for example in digital films.

Accordingly, such micromovements may be differentiated from macromovements, as are detected in the cited DE 10 2008 038 022 A1. Such macromovements are also inappropriate for determining the depth of sleep during a nap phase as they tend to occur toward the end of a sleep of many hours duration.

Even EEG (electroencephalography), which is regarded as a particularly reliable sleep phase indicator, may be potentially implemented in a motor vehicle with less disruption to the electroencephalographed person than using a conventional EEG cap, for example using capacitively-coupled electrodes in the head restraint of the vehicle seat and/or using dry contact electrodes in any object which the person otherwise wears on the head, for example data glasses, headphones or a headset which generally also communicate with the onboard electronics.

In other words, the physiological parameters may be measured by means of sensors of an electronic device incorporated in the motor vehicle and/or by means of sensors built into the motor vehicle. The electronic device incorporated in the motor vehicle may be a smartphone with a suitable app, a fitness watch, also called a fitness tracker, headphones, data glasses or the like, wherein the device naturally has to have a suitable sensor system. The sensors built into the motor vehicle may comprise a camera and/or sensors oriented toward the vehicle occupant and which are integrated in a vehicle seat or in a steering wheel.

The invention enables the vehicle occupant who is taking a nap to be woken reliably at a time when he/she has optimally benefited from the nap but is not woken from a deep sleep phase and continues to feel drowsy.

This is even more effective when, using the at least one physiological parameter, the time is also determined when the vehicle occupant actually falls asleep and when the time at which the vehicle occupant is woken is selected by considering the determined actual time of falling asleep. In other words, if the vehicle occupant requires some time for falling asleep, the waking up time is accordingly delayed and in this case the vehicle occupant also receives a sufficient nap in order to wake up refreshed again.

### BRIEF DESCRIPTION OF THE DRAWING FIGURES

A description of exemplary embodiments follows with reference to the drawings, in which:

FIG. 1 shows different system components and the cooperation thereof in a method for permitting a performance-enhancing nap.

FIG. 2 shows a block diagram of the flow of information and data processing in the method for permitting a performance-enhancing nap.

FIG. 3 shows a typical example of the changes to heart rate during sleep.

### DETAILED DESCRIPTION

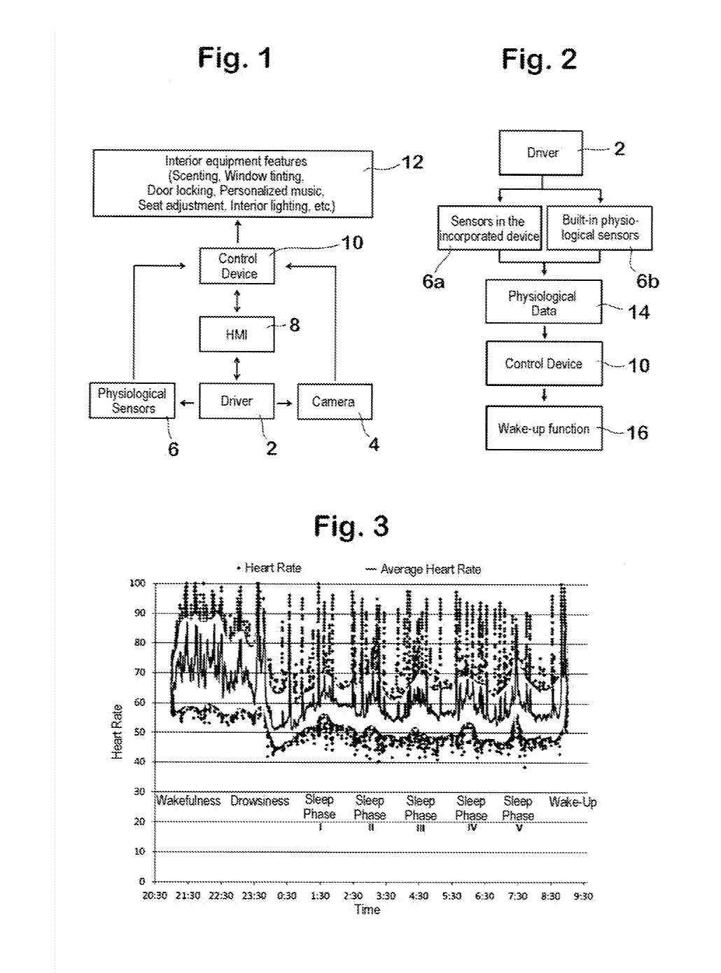

As illustrated in FIG. 1, a driver 2, an electronic camera 4 oriented toward the driver 2 and one or more physiological sensors 6 for ECG, EMG, breathing rate, etc. of the driver 2 are located in a motor vehicle. An HMI (human machine interface) 8 permits the driver 2 to operate a control device 10 and to receive communications therefrom.

The control device 10 receives data from the camera 4 and the physiological sensor(s) 6. The control device 10 is designed to process data received from the driver 2, the camera 4 and the physiological sensor(s) 6 and, when the driver 2 activates a nap function, to adjust a series of interior equipment features 12, such as for example door locking, seat adjustment, window tinting, variable interior light, personalized music, scent, etc. such that a performance-enhancing nap is promoted.

As illustrated in FIG. 2, the physiological sensors 6 which may be sensors 6a incorporated in a device built into the vehicle and/or worn on the body and/or sensors 6b built into the motor vehicle, register during the journey physiological parameters of the driver 2, such as for example heart rate, breathing rate, blood pressure, body temperature, muscle tone, in particular facial muscle tone, electrical skin resistance and/or electrical brain activity and deliver corresponding physiological data 14, the control device 10 calculating therefrom the current drowsiness or inattentiveness of the driver 2. If the drowsiness or inattentiveness of the driver 2 exceeds a preset value or a normal value obtained by lengthy observation of the driver, it is proposed to the driver 2 to park at a safe place and to have a catnap.

As soon as the driver 2 has parked, switched off the engine and switched on the nap function, the control device 10 adjusts the vehicle parameters or interior equipment features 12 as described above, in order to promote the nap. In particular, an automatically adjustable vehicle seat is moved into a more or less horizontal position and, in the case of a driver's seat which is only adjustable manually, the driver 2 is accordingly requested via the HMI 8 to carry out self-adjustment of the seat. The interior light is adapted and relaxing sounds or pieces of music are played in order to create a relaxed atmosphere. Depending on the currently prevailing air-conditioning conditions, the vehicle may be actively ventilated, for example, in order to produce a warm comfortable environment which promotes relaxation in the initial phase of the nap. The vehicle is also locked and no telephone calls are forwarded. The private space of the driver 2 may be improved by tinting the vehicle windows. Thus electrochromatic window tinting is present, wherein the translucency of the windows changes from translucent to semi-translucent or tinted, so that no one is able to look into the vehicle from the outside.

Whilst the nap function is switched on, the control device 10 monitors the driver 2 by means of the physiological sensors 6 and continuously calculates from the physiological data 14 the current depth of sleep of the driver 2. In order to improve the identification algorithm used, in this case the diurnal curve of the average performance of the driver which the driver 2 has input himself/herself or which has been transmitted wirelessly by a device built into the vehicle, such as, for example, a smartphone or an electronic fitness trainer, may also be taken into account. Such a device may also provide the physiological sensors or some of the physiological sensors 6a.

From the chronological pattern behavior of the current depth of sleep, the control device 10 determines the time when the driver 2 has actually fallen asleep and sets a minimum sleep duration of, for example, 20 minutes which may be a fixed preset value or may have been input by the driver. After the minimum sleep period has elapsed, the driver 2 is woken by a wake-up function 16, as soon as the next waking phase or semi-waking phase is identified between two deep sleep phases. If no phase which is suitable for waking is identified, the driver 2 is woken after a maximum sleep duration of, for example, 30 minutes which may be a fixed preset value or may have been input by the driver.

In any case, the driver 2 is gently woken by the wake-up function 16, for example by scenting the passenger compartment or vibrating the seat. Additionally, the relaxing measures taken for the nap, i.e. the appropriate adjustments to the interior equipment features 12, are reversed again, for example by slowly increasing the brightness of the passenger compartment.

The physiological parameters of the driver 2 used for identifying the depth of sleep are those which change from one sleep phase to another, such as for example heart rate, blood pressure and breathing rate. FIG. 3 shows a typical example of the changes to the heart rate before, during and after a long sleep. A substantial difference is observed between five deep sleep phases and a waking phase. Although it is not very clearly visible in the timescale of FIG. 3, such differences exist between deep sleep and light sleep even during the individual deep sleep phases and even toward the end of a nap lasting only ca. 20 to 30 minutes. These differences make it possible to determine a suitable time for waking up the driver 2.

Similar differences also exist for other physiological parameters, such as for example body temperature, muscle tone, electrical skin resistance and naturally electrical brain activity. Also, many different physiological parameters may be combined in order to improve the accuracy of identification and thus promote even better rest for the driver.

It should be noted that the drowsy phase preceding a sleep exhibits differences from normal wakefulness, the identification of the drowsiness or inattentiveness of the driver 2 being able to be based thereon in order to propose to the driver “to take a catnap.”

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method for permitting a performance-enhancing nap in a motor vehicle in which, when a vehicle occupant requests a nap function, different vehicle parameters are set such that the performance-enhancing nap is promoted and in which the vehicle occupant enjoying the nap is woken at a specific time, wherein during the nap function at least one physiological parameter of the vehicle occupant is measured, said parameter permitting conclusions to be drawn about the current depth of sleep, irrespective of any macromovements of the vehicle occupant, and wherein the time at which the vehicle occupant is woken is selected by considering the at least one physiological parameter, such that the vehicle occupant is woken as far as possible at a time of light sleep.

2. The method as claimed in claim 1, wherein using the at least one physiological parameter, the time is also determined when the vehicle occupant actually falls asleep, and wherein the time at which the vehicle occupant is woken is also selected by considering the determined actual time of falling asleep.

3. The method as claimed in claim 1, wherein the at least one physiological parameter is one or more of the parameters including heart rate, breathing rate, blood pressure, body temperature, muscle tone, in particular facial muscle tone, electrical skin resistance and electrical brain activity.

4. The method as claimed in claim 1, wherein at least one physiological parameter is measured by means of sensors of an electronic device incorporated in the motor vehicle.

5. The method as claimed in claim 4, wherein the electronic device incorporated in the motor vehicle is a smartphone with a suitable app, a fitness watch, headphones or data glasses.

6. The method as claimed in claim 1, wherein at least one physiological parameter is measured by means of sensors built into the motor vehicle.

7. The method as claimed in claim 6, wherein the sensors built into the motor vehicle comprise a camera oriented toward the vehicle occupant and/or sensors integrated in a vehicle seat or in a steering wheel.

8. A device for permitting a performance-enhancing nap in a motor vehicle, comprising:
A physiological parameter sensor for monitoring a physiological parameter of a vehicle driver; and
An electronic control device responsive to said physiological parameter sensor and configured to (a) propose said vehicle driver take a nap when drowsy, (b) adjust vehicle interior environment to promote napping upon actuation of a nap function and (c) awaken the driver after a predetermined period of time when the driver is in a light sleep phase.

9. The device of claim 8, wherein said device includes a camera.

10. The device of claim 8, wherein said device includes equipment for playing relaxing music.

11. The device of claim 8, wherein said device includes equipment for adjusting window tinting.

12. The device of claim 8, wherein said device includes equipment for scenting air in the vehicle.

13. The device of claim 8, wherein said device includes equipment for adjusting driver seating position in the vehicle.

14. The device of claim 8, wherein said device includes equipment for adjusting air temperature in said vehicle.
